(19) United States
(12) Patent Application Publication
(10) Pub. No.: US 2025/0128281 A1
(43) Pub. Date: Apr. 24, 2025

(54) PUSH BUTTON FOR PUMP TESTER, AND PUMP TESTER PROVIDED WITH SUCH A PUSH BUTTON

(71) Applicant: Frédérique GIANFERMI, BOULOGNE (FR)

(72) Inventor: Frédérique GIANFERMI, BOULOGNE (FR)

(21) Appl. No.: 18/688,310

(22) PCT Filed: Aug. 30, 2022
(86) PCT No.: PCT/IB2022/058110

§ 371 Date: Feb. 29, 2024

(30) Foreign Application Priority Data
Aug. 31, 2021 (FR) FR2109061
Oct. 18, 2021 (FR) FR2111061

(51) Int. Cl. B05B 14/00; A45D 34/02; B05B 11/10

(52) U.S. Cl. CPC B05B 14/00; A45D 34/02; B05B 11/1042; A45D 2200/057

(57) ABSTRACT

The invention relates to a pushbutton with a top outlet nozzle, as well as an assembly consisting of pump-type tester (3), pushbutton (5) and smelling blotter (21), wherein the pushbutton (5) comprises at least one perfume-outlet nozzle (7) emerging on the top face (15) of the pushbutton on which pressure is exerted to actuate the pump (3), aimed at eliminating skin contacts with the perfume testers.

The pushbutton comprises means for recovering the excess juice and for reducing the flow rate of the juice.

The present invention relates to the field of the sale of perfumes, including ambiance perfumes, and more precisely to perfume testers available on retail store shelves, whether they be positioned linearly or in a bar.

When it is wished to purchase a perfume in a retail store, the fragrance can be smelled before making the purchase, using a so-called “tester” bottle, making it possible to spray the perfume in question directly onto the skin, or onto a cellulose-based support often referred to by the term “smelling blotter”.

The tester, which is generally a product presented without its packaging and sometimes even without its cap, typically comprises a glass bottle filled with the perfume (or “juice”) to be tested, and a pump mechanism attached to the spout of the bottle, on which a pushbutton provided with a spray nozzle is mounted.

When a pressure is exerted on the pushbutton, perfume can be sprayed onto the skin or onto a smelling blotter.

This operation supposes that a female user (who may of course also be a male user, without this being specified each time hereinafter) presses on the pushbutton with a finger, and is therefore put in direct skin contact with the pushbutton, or even with the bottle itself, if she grips the latter.

She will first have to check that the hole in the nozzle is facing the smelling blotter or the skin before pressing on the pushbutton, since very often the pushbutton turns on itself, leaving the nozzle hole in a random position, which therefore obliges the user to make to manipulations on the bottle and therefore multiplies the skin contacts with the tester.

These manipulations are not favorable from a hygienic point of view, the pushbutton and/or the bottle being in fact able to constitute media for transmitting germs (bacteria, viruses) between the various persons using the tester.

The aim of the present invention is in particular to eliminate these drawbacks relating to the testers of the prior art, and to eliminate all skin contact with the users, without being deprived of the possibility of testing the fragrance.

Another aim of the present invention is to avoid the excess juice sprayed during a test being spread on the bottle of the tester and on the furniture on which this bottle is placed, it being observed that the quantity of juice necessary for making a test is appreciably less than that which is expelled during a normal perfuming operation.

This aim of the invention is achieved with a pushbutton for pump-type tester, comprising at least one nozzle for vertical discharge of the juice emerging on the top face of the pushbutton intended to receive the actuation pressure of a user, and means for recovering the excess juice during a test spray.

By virtue of this particular arrangement, it is possible to actuate the pump without having to grip the bottle or take care to replace the nozzle hole in the correct direction, simply by pressing with a finger, preferably protected by a smelling blotter, or with another part of the body on the pushbutton, which makes it possible to have no contact with any part of the tester.

Such a pushbutton, which allows spraying of the perfume upwards, i.e. in the direction of the finger of the operator, can be fitted on existing testers, without any modification of the pump mechanism of the latter; according to the variants that will be disclosed below, this pushbutton according to the invention can be mounted directly on the pump mechanism of the tester, in place of the original pushbutton, or be fitted on this original pushbutton.

This pushbutton according to the invention can be presented in the same color as the color of the existing pump, or adopt any other more visible color, in order to draw attention to this new fragrance test action.

Any type of material (plastic, metal, Zamac, biodegradable Sulapac resin, etc.) can be used for manufacturing the pushbutton according to the invention.

In addition, the means for recovering the excess juice make it possible to avoid part of the juice expelled during a test falling by running along the bottle.

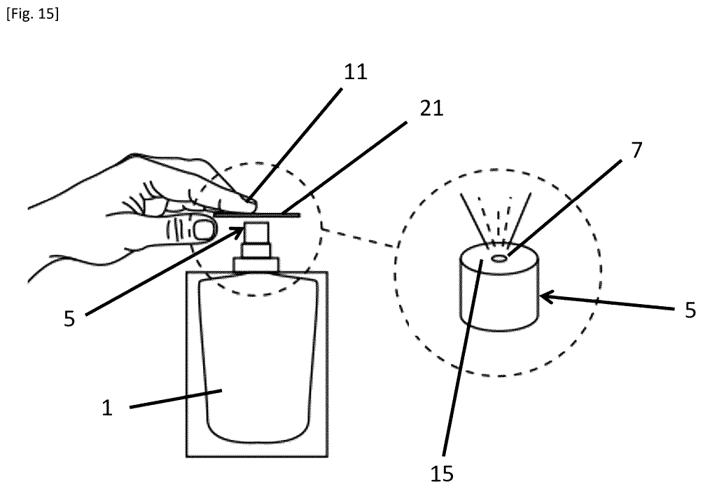

When the tester is used with a smelling blotter placed between the top part of the pushbutton and the finger of the user in order to avoid any skin contact with the tester (see description below and FIG. 15), the means for recovering the excess juice make it possible not to wet the finger of the user: all the juice is absorbed by the smelling blotter, the overflow being discharged to the excess-juice recovery means.

According to other optional features of the pushbutton according to the invention, taken alone or in combination:
said excess-juice recovery means comprise a peripheral groove formed inside said pushbutton, first and second orifices defining an excess-juice recovery chamber, and walls for trickling of this excess juice between said chamber and said groove: this arrangement makes it possible in a simple manner to conduct the excess juice to a retention zone formed by the pushbutton groove. This peripheral groove can be equipped as necessary with a material with a high absorbance of the foam or peat moss type, in order to avoid saturation thereof during intensive use;
said pushbutton comprises ventilation means adapted to allow evaporation of the excess juice recovered: these ventilation means allow evaporation of the juice and diffusion of the associated fragrance;
said pushbutton furthermore comprises means for reducing the fragrance flow rate: these flow rate reduction means, which can comprise an orifice with a smaller diameter compared with the inside diameter of the cannula of the pump mechanism of the tester, limit the excess juice expelled during a test;
said top face is in the form of a rounded bowl, at the bottom of which said nozzle emerges;
said pushbutton is in the form of a funnel with a thin rounded edge; the rounded shape makes it possible not to injure the user;
said top face is in the form of a recessed plateau, on which said nozzle emerges;
said nozzle emerges in a way that is slightly protuberant with respect to said top face, and includes radial outlet openings;
said pushbutton has an enveloping shape with respect to that of the tester pump; this pushbutton can in particular have the same shape as the original cap of any bottle in order not to impair the general appearance of the product;
said pushbutton is adapted to be substituted for an original pushbutton of the tester;
said pushbutton is adapted to fit sealingly on an original pushbutton provided with a nozzle with a horizontal axis, said pushbutton including at least one top nozzle communicating sealingly with the horizontal-axis nozzle: the pushbutton according to the invention can thus adapt to the original pushbutton, which avoids having to remove the latter;
said pushbutton includes at least one channel connecting said at least one top nozzle to said horizontal-axis nozzle, and an annular seal able to make a sealed connection with said original pushbutton;
said pushbutton comprises a plurality of top nozzles and a plurality of channels respectively connecting these top nozzles to said horizontal-axis nozzle.

The present invention also relates to a tester equipped with a pushbutton according to the above.

The present invention also relates to an assembly comprising a tester according to the above, and at least one smelling blotter able to receive a spray of perfume coming from said tester.

The present invention also relates to an assembly comprising a tester according to the above, and to a support for maintaining the stability of this tester.

The present invention also relates to the use of a tester according to the above, wherein a smelling blotter is gripped and positioned at the end of the finger, and the top face of said pushbutton is pressed without touching said tester, or the top face of said pushbutton is pressed directly with a part of the body little liable to carry germs, such as a wrist or forearm.

Other features and advantages of the invention will emerge from the reading of the following description, with reference to the accompanying figures, which illustrate:

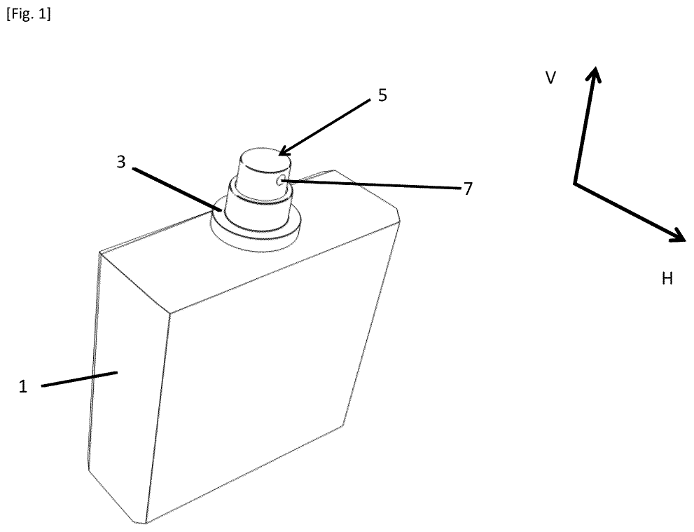

FIG. 1: a perspective view of a conventional tester, on which a pushbutton with horizontal-outlet nozzle is mounted,

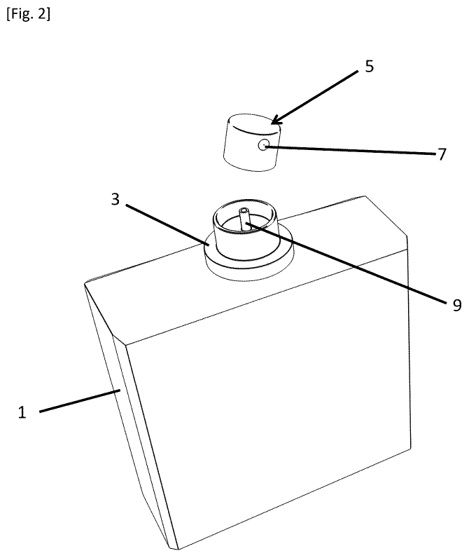

FIG. 2: a perspective view of this tester at another angle, the pushbutton being shown in the removed position,

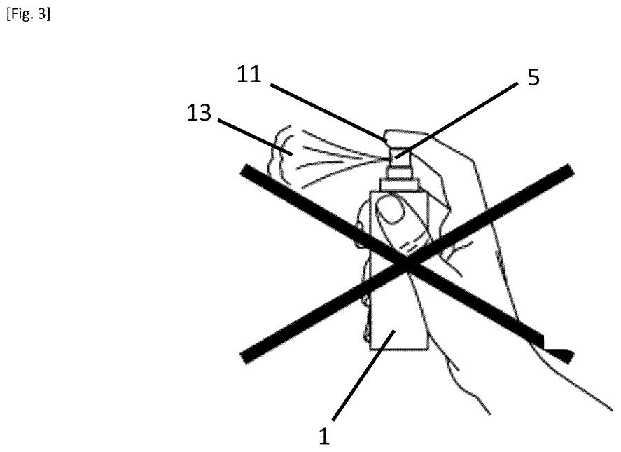

FIG. 3: the action that it is sought to avoid, to avoid transmitting germs,

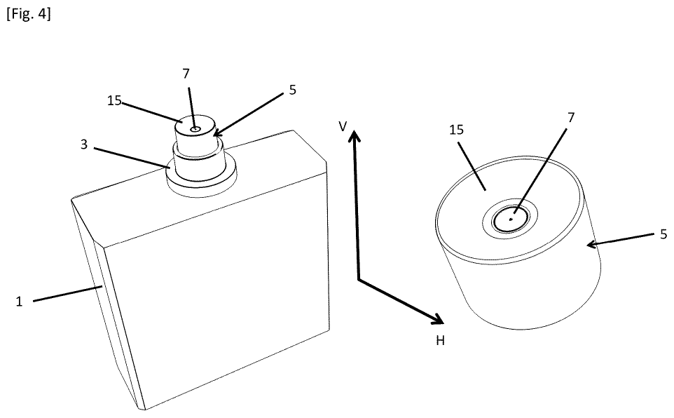

FIG. 4: a perspective view of a tester equipped with a pushbutton with vertical-outlet nozzle according to the invention, as well as this pushbutton itself shown independently of the bottle, according to a first embodiment,

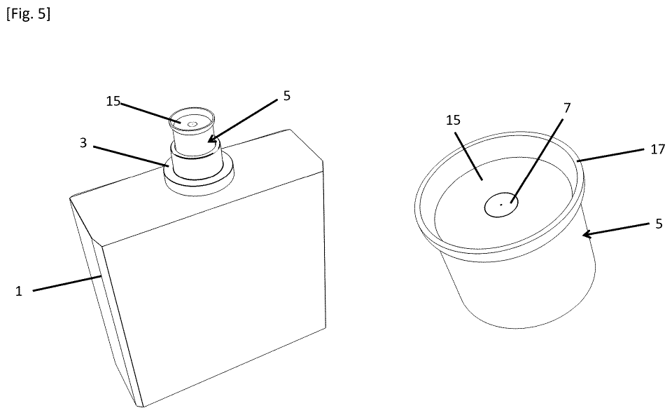

FIG. 5: a view similar to that of FIG. 4 of another embodiment of the pushbutton,

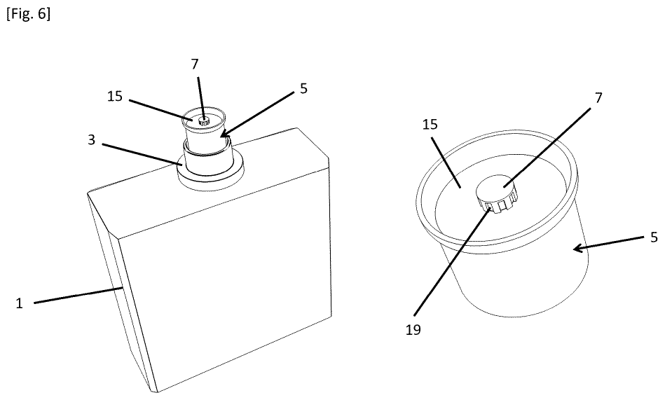

FIG. 6: a view similar to that of FIGS. 4 and 5, showing yet another embodiment of the pushbutton,

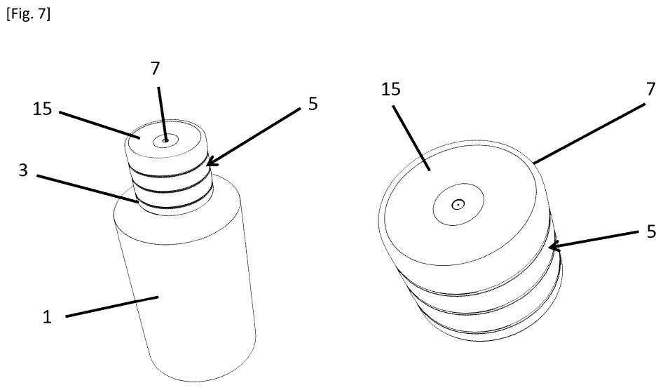

FIG. 7: a view similar to that of FIGS. 4 to 6, showing yet another embodiment of the pushbutton,

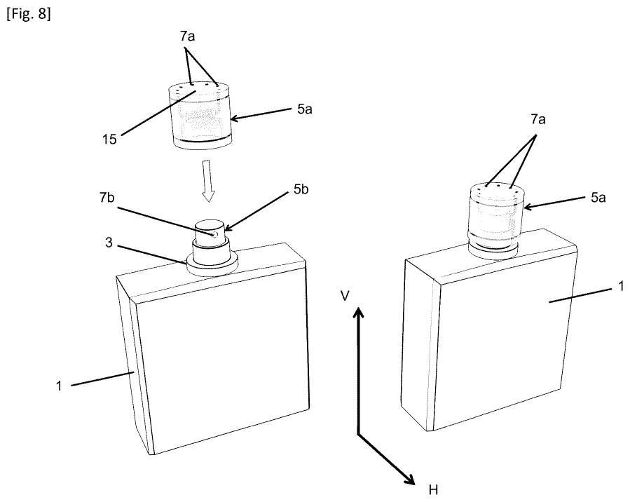

FIG. 8: a perspective view of a tester equipped with an original pushbutton, on which a pushbutton according to the invention produced according to another variant is fitted; the left-hand view shows the pushbutton according to the invention being positioned on the original pushbutton, and the right-hand view shows this pushbutton according to the invention fitted on the original pushbutton,

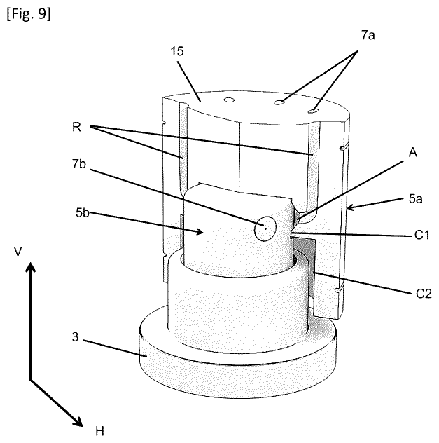

FIG. 9: a perspective view of the original pushbutton of the tester of FIG. 8, on which the pushbutton according to the invention of FIG. 8 is fitted, the latter being shown in axial section and in perspective,

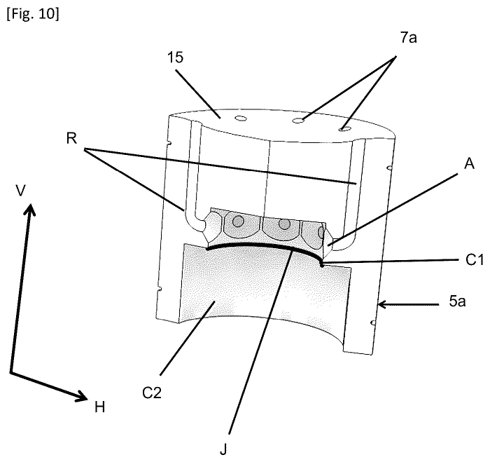

FIG. 10: a view in axial section and in perspective of the pushbutton according to the invention of FIGS. 8 and 9, this being shown alone,

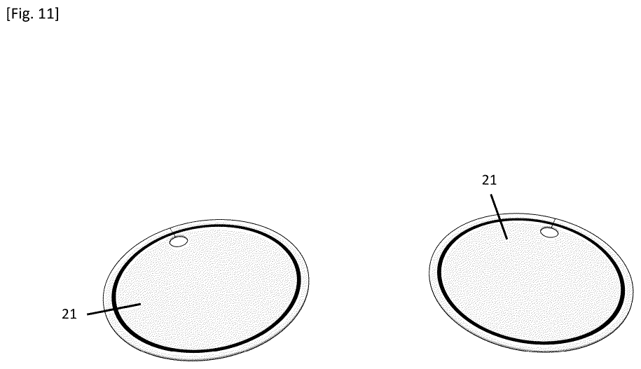

FIG. 11: perspective views of the front and back faces of a smelling blotter according to the invention, according to a first embodiment,

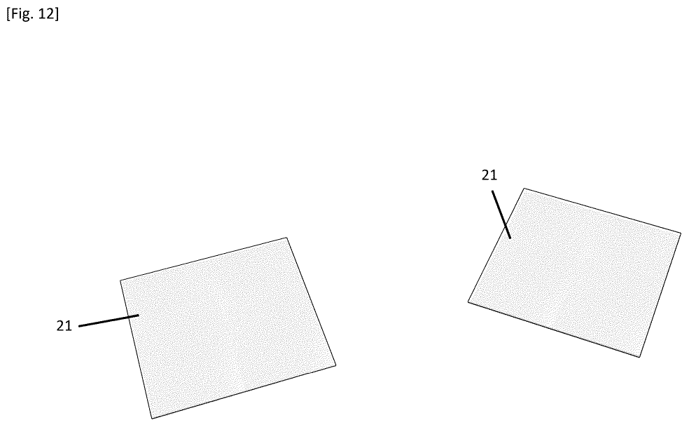

FIG. 12: views similar to that of FIG. 11, showing another embodiment of a smelling blotter,

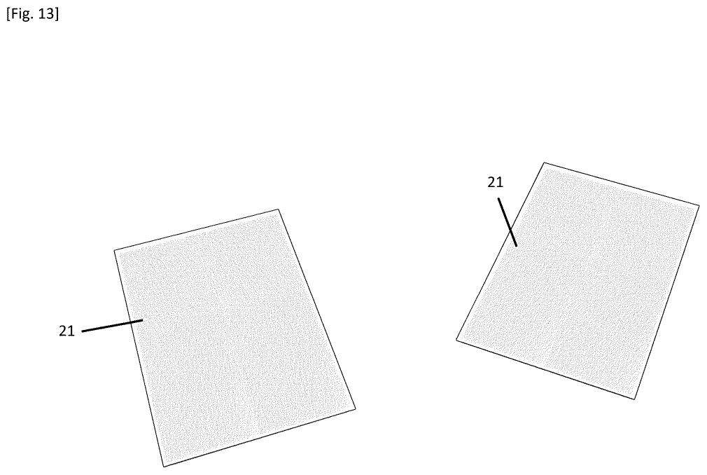

FIG. 13: views similar to those of FIGS. 11 and 12, showing yet another embodiment of a smelling blotter,

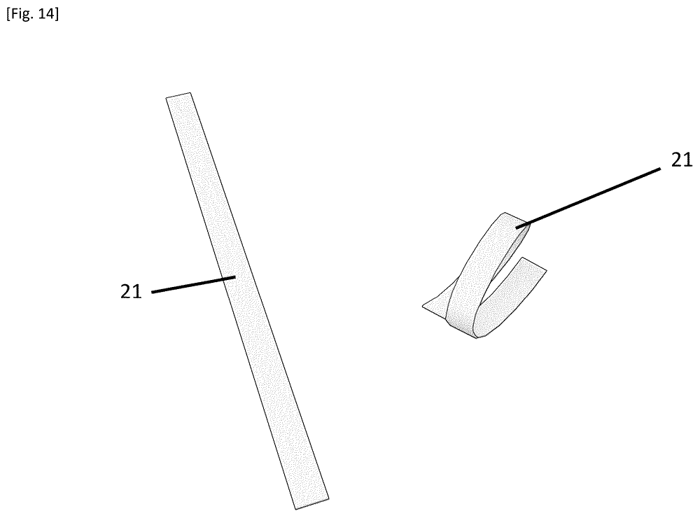

FIG. 14: views similar to those of FIGS. 11 and 13, showing yet another embodiment of a smelling blotter,

FIG. 15: shows the action that can be performed to use the tester according to the invention,

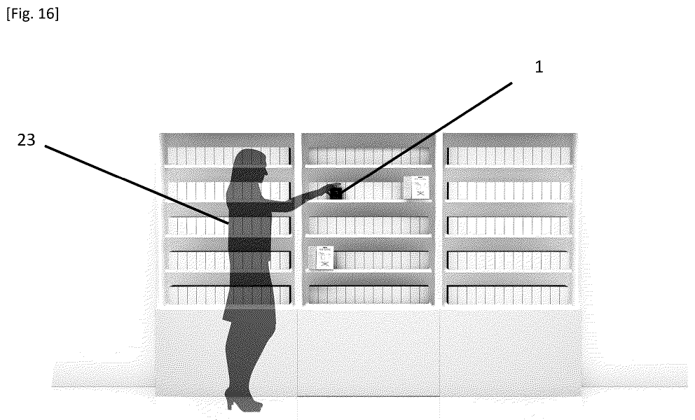

FIG. 16: the action of a user actuating the tester according to the invention, the latter being disposed at the top part of a stack of shelves, and

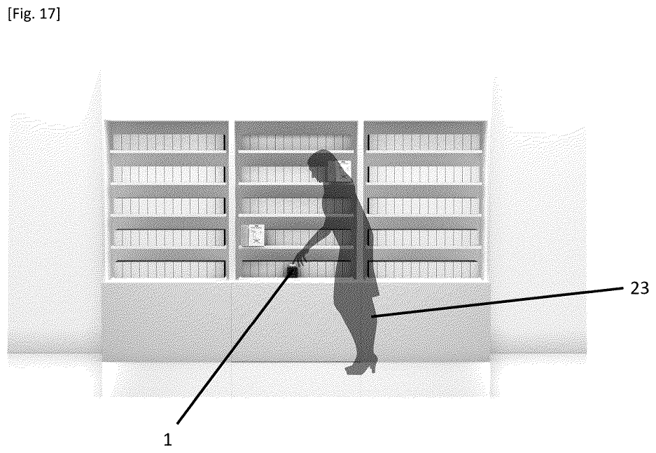

FIG. 17: this action in the case where the tester is disposed on a lower part of this stack of shelves,

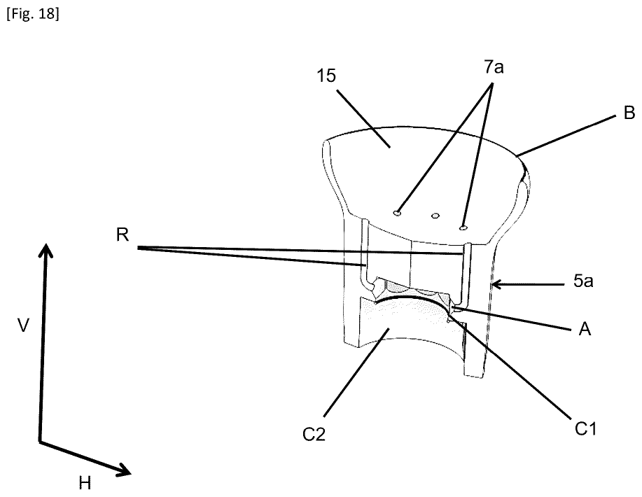

FIG. 18: a view in axial section and in perspective of yet another variant of a pushbutton according to the invention, intended to be fitted on an original pushbutton,

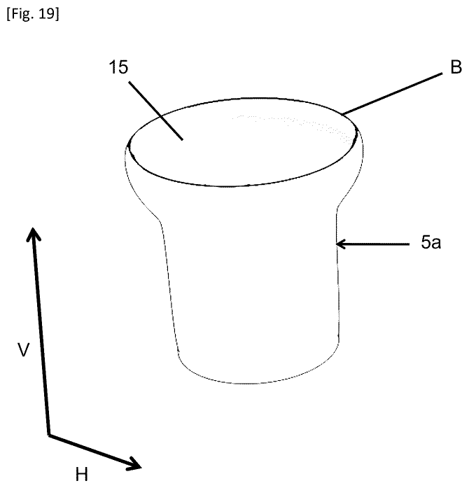

FIG. 19: a perspective view of the pushbutton of FIG. 18,

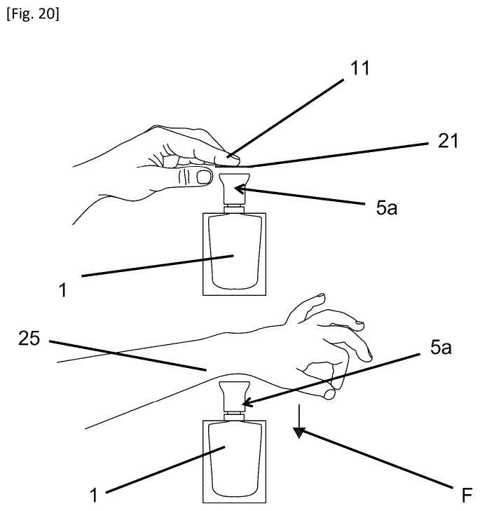

FIG. 20: on the top view and on the bottom view, two types of action that can be performed with a tester equipped with a pushbutton according to the invention in accordance with FIGS. 18 and 19,

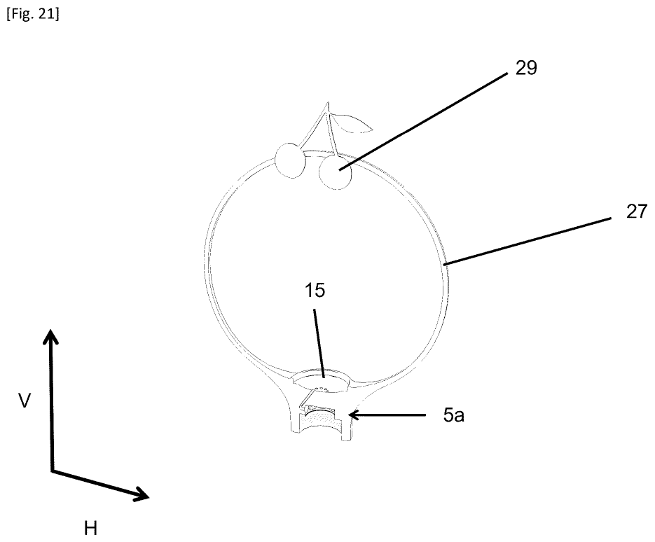

FIG. 21: a view in axial section and in perspective of yet another variant of a pushbutton according to the invention, intended to be fitted on an original pushbutton,

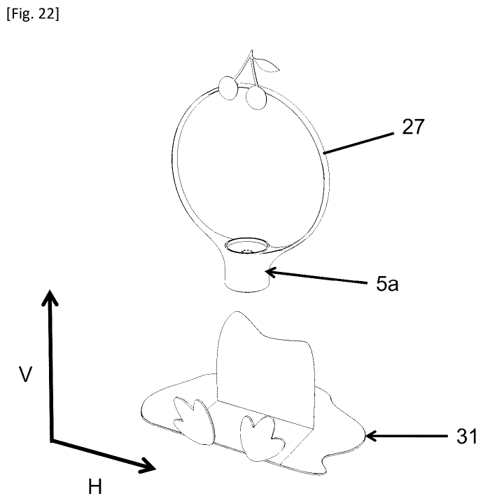

FIG. 22: a perspective view of the pushbutton of FIG. 21, and of an associated tester support,

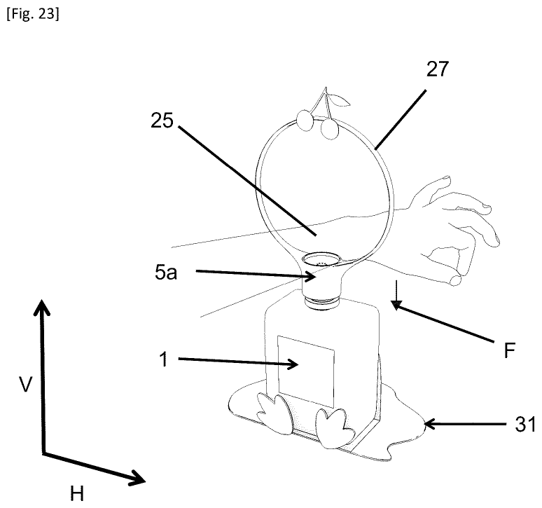

FIG. 23: the action that can be performed with a tester equipped with a pushbutton according to the invention in accordance with FIGS. 21 and 22,

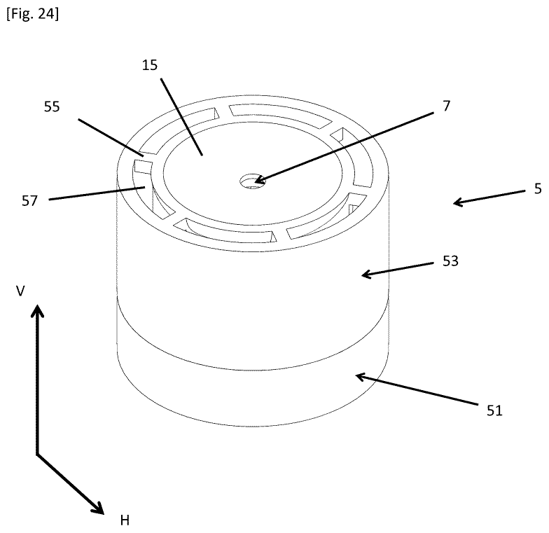

FIG. 24: a perspective view of yet another variant of the pushbutton according to the invention, provided with a device for recovering excess juice,

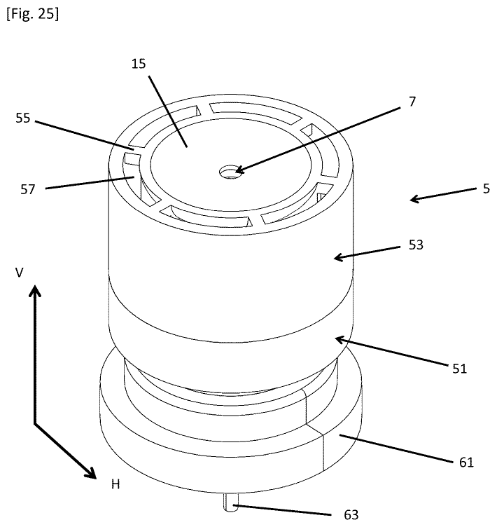

FIG. 25: a similar view of the pushbutton of FIG. 24, when it is mounted on the pump mechanism of a tester bottle,

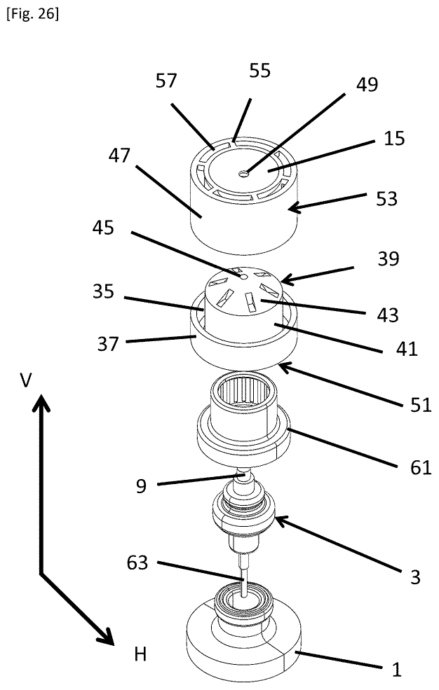

FIG. 26: a view in exploded perspective of the pushbutton of FIGS. 24 and 25 and of the associated tester bottle,

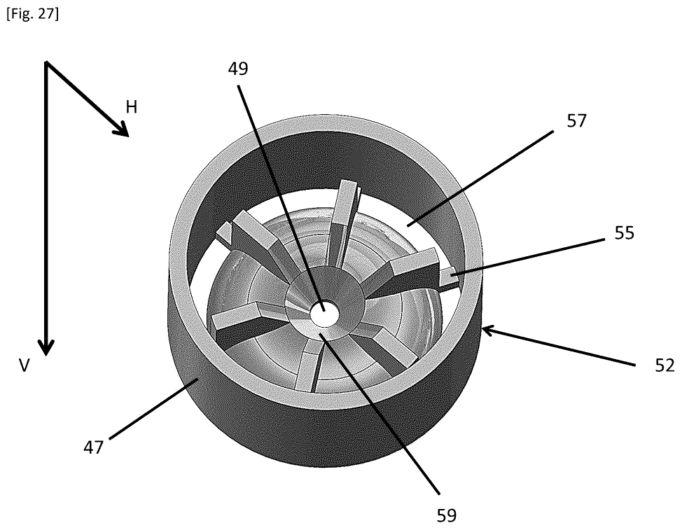

FIG. 27: a perspective view of the top part of the pushbutton of FIGS. 24 to 26, and

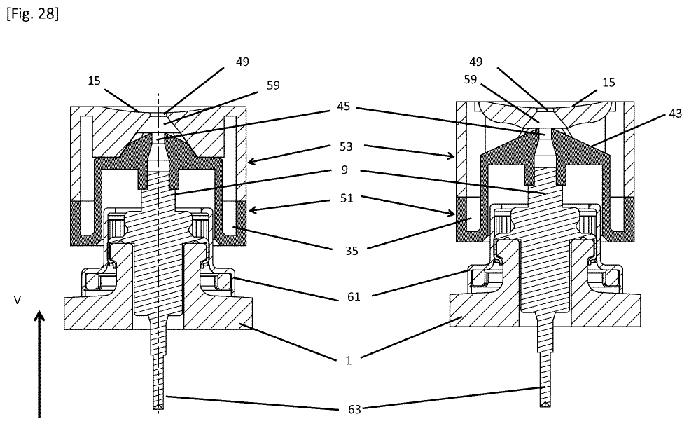

FIG. 28: the views, taken in two different axial cutting planes, of the pushbutton of FIGS. 24 to 26 mounted on the pump mechanism of a tester bottle.

For greater clarity, identical or similar elements are marked by identical or similar reference signs over all the figures.

Hereinafter, the terms “horizontal”, “vertical” and “top” will be used: these terms must be understood with respect to the normal position of a bottle placed on a support in a store.

The horizontal and vertical directions are indicated for example on FIGS. 1 and 4 by means of arrows H and V, the pointed end of the V arrow pointing towards the top of the place where the bottle is placed.

Consequently, the term “top” indicates the upper part of the pushbutton, i.e. the part of the pushbutton located closest to the pointed end of the V arrow.

Reference is now made to FIG. 1, on which a conventional tester can be seen, typically comprising a bottle 1 preferably produced from glass, on the spout of which a pump mechanism 3 provided with a plunger tube (not shown) is attached. A pushbutton 5 is mounted on the pump mechanism 3.

This pushbutton 5 includes a nozzle 7, which emerges on a lateral face of this pushbutton, with a horizontal-spray jet, and which is in fluid communication with a cannula 9 (see FIG. 2) secured to the pump mechanism 3.

To actuate such a tester, as is visible on FIG. 3, typically the bottle 1 is gripped and, with a finger 11, generally the index finger, the pushbutton 5 is pressed, so as to cause a cloud of perfume 13 to emerge through the nozzle 7, in a direction substantially perpendicular to the axis of the pump mechanism 3.

As can be understood simply by examining FIG. 3, this action supposes the user gripping and coming into contact with the tester, which is not hygienic since this poses the problem of transmitting germs between the tester and the hand of the user.

To remedy this drawback, and as can be seen first of all on FIG. 4, the outlet of the nozzle 7 is moved, so that it emerges on the top face 15 of the pushbutton 5, i.e. on the face on which the user will press by means of one of her fingers, preferably protected by a smelling blotter (see below).

In other words, the axis of the nozzle 7 is coincident with that of the cannula 9, instead of being perpendicular thereto: this axis is vertical instead of being horizontal.

In the variant shown on FIG. 4, the top face 15 of the pushbutton 5 is in the form of a rounded bowl, at the bottom of which the nozzle 7 emerges.

In the variant shown on FIG. 5, the top face 15 of the pushbutton 5 on which the nozzle 7 emerges is surrounded by a collar 17, slightly wider than the diameter of the standard pushbutton in order to increase the contact surface between the smelling blotter and the fingers that will produce pressure, so that the face 15 forms a kind of plateau recessed with respect to this collar 17.

The variant in FIG. 6 is distinguished from that of FIG. 5 in that the nozzle 7 emerges so as to be slightly protuberant with respect to the recessed face 15, and is provided with a plurality of radial perfume outlets 19, in order to avoid the juice being too close to the smelling blotter and wetting only a very small surface of the smelling blotter.

In the variant in FIG. 7, which shows a so-called “decorative” pushbutton, the pushbutton 5 has a diameter greater than that of the part of the pump mechanism that surmounts the neck of the bottle 1, so as to cover this part.

The pushbutton 5 can also represent the shape of the original cap of the perfume (“trompe l′œil” pushbutton), so that the bottle keeps its original design and is more presentable on a major-brand perfume bar that is particularly invested in keeping the aesthetic appearance of the bottle in order to trigger the action of purchasing.

FIG. 7 shows a top face 15 of the pushbutton 5 that is substantially flat and at the centre of which the nozzle 7 emerges, on the understanding that any one of the forms of the top face 15 shown in FIGS. 4 to 6 could be used in this variant of FIG. 7.

In the variant shown in FIGS. 8 to 10, the pushbutton 5a according to the invention is conformed so as to be able to fit on the original pushbutton 5b of the bottle.

As is more particularly visible on FIGS. 9 and 10, the pushbutton according to the invention 5a includes for this purpose a first cylindrical cavity C1 adapted to fit on the original pushbutton 5b, and a second cavity C2 with a larger diameter, able to cover, with a both axial and radial clearance, the top part of the pump mechanism 3.

On its top part, the pushbutton 5a according to the invention includes a plurality of orifices or nozzles 7a, preferably equally distributed over a circle, which communicate via respective vertical channels R with a peripheral reservoir A slightly retracted radially (i.e. having a larger diameter) with respect to the interior surface of the cylindrical cavity C1.

This peripheral reservoir A thus allows fluid communication of the nozzle 7b of the original pushbutton 5b with the channels R, and therefore with the nozzles 7a.

An annular seal J made from rubber is furthermore provided on the bottom edge of the cylindrical cavity C1, so as to sealingly close the peripheral reservoir A on the original pushbutton 5b.

The pushbutton 5a according to the invention can have a generic form, as shown in FIGS. 8 to 10, or have a stylized form, representing a given brand, as mentioned with regard to FIG. 7.

FIG. 11 shows a smelling blotter that can form part of the assembly according to the invention.

In the variant shown in this figure, this smelling blotter, which can be manufactured from a specific paper with greater or lesser thickness, has a substantially circular shape.

In the variant shown in FIG. 12, the smelling blotter has a substantially square shape.

In the variant shown in FIG. 13, this smelling blotter has a substantially rectangular shape.

In the variant shown in FIG. 14, this smelling blotter has a substantially elongated shape, i.e. in a strip, and can be wound around the finger (right-hand view): this type of smelling blotter is found in the majority of perfume outlets.

The method of use and the advantages of the test assembly that has just been described result directly from the above.

When a user wishes to smell a fragrance before making a purchase, she goes to a tester available on the shelves of the store, this tester being able to be in accordance with the one in any one of FIGS. 4 to 10.

Smelling blotters may be found in proximity to this tester, and may be in accordance with those of any one of FIGS. 11 to 14.

The user grips a smelling blotter 21, placing for example her index finger 11 on the top face thereof, as shown in FIG. 15, and presses on the pushbutton 5 or 5a by means of this smelling blotter 21, without touching the bottle 1, or any other part of the tester.

As the nozzle or nozzles 7, 7a emerge on the face 15 on which the finger 11 of the user is exerting a pressure force, the perfume emerging from the nozzle or nozzles 7, 7a will impregnate the smelling blotter 21 without the user having had to touch any part of the tester.

In the case where the top face 15 of the pushbutton 5 has a bowl or recessed shape as shown on FIGS. 4 to 6, the smelling blotter 21 closing off the nozzle 7 can be avoided at the same time as creating a juice-retention zone, making it possible to better soak this smelling blotter 21.

In the case where the nozzle 7 has radial outlet orifices 19 as shown in FIG. 6, the perfume can emerge radially through the nozzle, which further limits the risk of blocking by the smelling blotter 21 under the pressure force exerted by the finger 11 of the user.

In the case where the smelling blotter has a substantially elongate shape as shown in FIG. 14—which is the case with smelling blotters that are found in the majority of perfume points of sale—the user can wind it around her index finger, as suggested by the right-hand view in this figure.

In the store, the tester according to the invention can be positioned on a high shelf (FIG. 16), or on a low shelf (FIG. 17), or on a perfume bar like the ones that can be found in the flagship stores of major brands.

In both cases, the user 23 has no need to grip the tester: as shown on FIGS. 16 and 17, she merely has to stretch out her arm and press on the pushbutton of the tester by means of a single finger using a smelling blotter.

By virtue of the assembly according to the invention, any contact between the hand of the user and the tester is eliminated, which is particularly satisfactory from a hygienic point of view.

The risks of theft of the testers is furthermore limited, since a pushbutton with a nozzle with top outlet makes the tester very impractical to use as an everyday perfume bottle.

As will be able to be understood in the light of the above, the pushbutton 5 provided with a nozzle 7 emerging on its top face 15, i.e. on its face on which the user presses with a finger, can be fitted on an existing tester, without any modification to the pump mechanism being necessary.

Naturally, each manufacturer of a nozzle 7 uses specific characteristics for this nozzle, according to the specification imposed by the perfume house, and it will be understood that the pushbutton of the assembly according to the invention can incorporate any type of nozzle.

In the particularly advantageous variant shown in FIGS. 8 to 10, the pushbutton according to the invention 5a is fitted on the original pushbutton 5b, which avoids having to remove the latter; the redirection of the jet of juice upwards, to the nozzles 7a emerging in the top part of the pushbutton 5a, is provided by the axial channels R, the sealing for its part being provided by the seal J.

Naturally, the invention is described above by way of example. A person skilled in the art is of course in a position to implement various variant embodiments of the invention without departing from the scope of the invention.

In the variant shown in FIGS. 18 and 19, the pushbutton according to the invention 5a is substantially in the form of a funnel, with a thin rounded edge B.

As can be seen on FIG. 20, such a pushbutton 5a can be actuated by the finger 11 of a user by means of a smelling blotter 21, or by the forearm 25 of the user pressing on the pushbutton in the direction F, with the minimum contact surface with the skin because of the thinness of the edge B.

The variant shown in FIGS. 21 to 23 is particularly intended for children: in this variant, the pushbutton according to the invention 5a is surmounted by a ring 27 that can comprise decorative elements 29.

In this variant, a tester support 31 is also provided, in which the bottle 1 is embedded, as can be seen in FIG. 23.

A child wishing to test the perfume inserts their forearm 25 inside the ring 27, and exerts a downward pressure on the pushbutton 5a, as indicated by the arrow F; during this movement, the tester support 31 provides stability of the bottle 1.

Using the forearm 25 rather than a finger 11 reduces the risk of contamination, the forearm in general being less of a germ carrier than the fingers of the hand.

Reference is now made to FIGS. 24 to 28, on which yet another variant of a pushbutton 5 according to the invention has been shown.

In this variant, the pushbutton 5 comprises means for recovering the excess juice sprayed by the top nozzle 7 during a vertical pressure exerted by a user on this pushbutton.

This is because the pump mechanism 3 mounted on the bottle 1 is sized to spray a quantity of juice corresponding to the needs of a person wishing to perfume themselves: this quantity of juice is appreciably greater than what is strictly necessary when it is wished to test the perfume in the store.

Thus, in practice, when the tester is used, an excessively large quantity of juice frequently emerges from the nozzle of this tester, some of this juice then being lost and running along the pump mechanism 3 and bottle 1 of the tester, which is obviously not satisfactory both from an economic point of view and from an aesthetic point of view.

To remedy this drawback, a groove 35 for recovering the excess juice can be produced in the pushbutton 5, as can be seen in particular in FIGS. 26 and 28.

More precisely, this pushbutton 5 is for this purpose produced in two parts, namely a bottom part 51 and a top part 53.

As can be seen in particular on FIGS. 26 and 28, the bottom part 51 comprises an annular wall 37 defining, with a central part 39, the groove 35 for recovering excess juice.

The central part 39 is itself in the form of a ferrule 41 surmounted by a conical bonnet 43, the conical bonnet 43 being provided at its top with a first nozzle orifice 45.

The top part 53 of the pushbutton itself comprises a cylindrical wall 47 surmounted by a bowl 15 provided at its centre with a second nozzle orifice 49.

The first nozzle orifice 45 has a diameter less than the inside diameter of the cannula 9.

As can be seen in particular on FIGS. 25 and 27, the bowl 15 is connected to the cylindrical wall 47 by ribs 55 defining a plurality of ventilation openings 57 in the form of arcs of a circle.

As can be seen on FIG. 28, when the bottom parts 51 and top parts 53 of the pushbutton 5 are attached to each other, the two orifices 45, 49 are located facing each other, the zone 59 located between these two orifices defining a substantially frustoconical chamber.

The pushbutton 5 thus assembled can next be attached to the cannula 9 of the pump mechanism 3, by virtue of a complementary geometry of the bottom part 51 of the pushbutton 5, this geometry also enabling this bottom part 51 to be fitted on the neck 61 of the pump mechanism 3.

The operating method and the advantages of this variant are as follows.

When a user exerts a vertical pressure force on the pushbutton 5, the juice located in the bottle 1 is sucked by the plunger channel 63 and expelled by the cannula 9 in the direction of the first 45 and second 49 orifices.

The first orifice 45, the diameter of which is less than the inside diameter of the cannula 9, reduces the flow rate of juice expelled, so as to allow only the strictly sufficient quantity of juice to pass to perform the test.

The rest of the juice remains trapped inside the frustoconical chamber 59, and falls again by capillarity and trickling on the conical bonnet 43 of the bottom part 51 of the pushbutton, and then trickles along the wall of the ferrule 41 as far as the interior of the groove 35.

This excess juice thus remains in this groove 35, instead of flowing along the pump mechanism 3 and bottle 1 of the tester.

The ventilation openings 57 formed in the top part of the pushbutton allow the diffusion of the perfume of the juice towards the outside and the gradual evaporation of this juice.

This variant makes it possible to avoid the spraying of an excessively large quantity of juice during the test.

Naturally, the invention is in no way limited to the variants described and depicted, provided by way of illustration.

In particular, the teachings of these various variants can be combined with each other without departing from the scope of the present invention.

In particular, the teaching about the recovery of the excess juice of the variant in FIGS. 24 to 28 can be combined with the variants in FIGS. 9, 10 and 18 of a pushbutton attached by sealed embedding on the existing pushbutton.

What is claimed is:

1. A pushbutton for pump-type tester, comprising at least one nozzle for vertical discharge of the juice emerging on the top face of the pushbutton intended to receive the actuation pressure of a user, and means for recovering the excess perfume during a test spray.

2. The pushbutton according to claim 1, wherein said excess juice recovery means comprise a peripheral groove formed inside said pushbutton, first and second orifices defining an excess juice recovery chamber, and walls for trickling of this excess juice between said chamber and said groove.

3. The pushbutton according to claim 1, comprising ventilation means adapted to allow evaporation of the excess juice recovered.

4. The pushbutton according to claim 1, characterized in that it furthermore comprises means for reducing the flow rate of juice.

5. The pushbutton according to claim 1, wherein said top face is in the form of a rounded bowl, at the bottom of which said nozzle emerges.

6. The pushbutton according to claim 1, being in the form of a funnel with a thin edge.

7. The pushbutton according to claim 1, including a ring for introducing the hand.

8. The pushbutton according to claim 1, wherein said top face is in the form of a recessed plateau, on which said nozzle emerges.

9. The pushbutton according to claim 1, wherein said nozzle emerges in a way that is slightly protuberant with respect to said top face, and includes radial outlet openings.

10. The pushbutton according to claim 1, having an enveloping shape with respect to that of the pump of the tester.

11. The pushbutton according to claim 1, adapted to be substituted for an original pushbutton of the tester.

12. The pushbutton according to claim 1, adapted to fit sealingly on an original pushbutton provided with a nozzle with a horizontal axis, said pushbutton including at least one top nozzle communicating sealingly with the horizontal-axis nozzle.

13. The pushbutton according to claim 12, including at least one channel connecting said at least one top nozzle to said horizontal-axis nozzle, and an annular seal able to make a sealed connection with said original pushbutton.

14. The pushbutton according to claim 13, comprising a plurality of top nozzles and a plurality of channels (R) respectively connecting these top nozzles to said horizontal-axis nozzle.

15. A tester assembly, comprising a pushbutton that includes—at least one nozzle for vertical discharge of the juice emerging on the top face of the pushbutton intended to receive the actuation pressure of a user, means for recovering the excess perfume during a test spray; and at least one smelling blotter able to receive a spray of perfume coming from said tester.

16. (canceled)

17. The tester assembly according to claim 15, further comprising a support for maintaining the stability of this tester.

18. (canceled)
